(19) United States
(12) Patent Application Publication
(10) Pub. No.: US 2024/0386393 A1
(43) Pub. Date: Nov. 21, 2024

(54) Methods of Imputing Attribute Information for Infrastructure Elements

(71) Applicant: Fracta, Inc., Palo Alto, CA (US)

(72) Inventors: Takashi Kato, Palo Alto, CA (US); Lars Stenstedt, Alameda, CA (US); Minoda Kazuma, Koto-ku (JP); Alexander Gomory, Rancho Cucamonga, CA (US); Liuha Sang, Shenyang Shi (CN); Te Hao Liu, Eastvale, CA (US); Ted Sindabizera Ntwari, Redwood City, CA (US); Anton Lakhtikov, Palo Alto, CA (US); Kaichi Momose, Redwood City, CA (US); Hideki Okada, Irvine, CA (US); Chase Rowe, Palo Alto, CA (US)

(21) Appl. No.: 18/664,212

(22) Filed: May 14, 2024

Related U.S. Application Data
(60) Provisional application No. 63/502,624, filed on May 16, 2023.

(51) Int. Cl. G06Q 10/20; G06F 3/0482; G06F 3/0484

(52) U.S. Cl. CPC G06Q 10/20; G06F 3/0482; G06F 3/0484

(57) ABSTRACT

An electronic device receives attribute information for a first plurality of pipes, a second plurality of pipes, and a plurality of supply-side structures. The attribute information for the first plurality of pipes includes, for each pipe, location information and a value for a characteristic. The attribute information for the second plurality of pipes includes, for each pipe, location information, and does not include values for the characteristic. The attribute information for the plurality of supply-side structures includes location information. The electronic devices determines, for each respective pipe of the second plurality of pipes, unknown attribute information, including: determining, based on the attribute information for the plurality of supply-side structures and location information for the respective pipe, an adjacent pipe connected to the respective pipe; and determining, based on a respective value for the characteristic for the adjacent pipe, a value for the characteristic for the respective pipe.

### RELATED APPLICATIONS

This application claims priority to U.S. Provisional Application No. 63/502,624, filed May 16, 2023, entitled “Methods of Imputing Attribute Information for Infrastructure Elements,” which is hereby incorporated by reference in its entirety.

### TECHNICAL FIELD

This disclosure relates generally to infrastructure maintenance, including but not limited to, methods of imputing attribute information for infrastructure elements of a network of infrastructure elements, based at least in part on known attribute information for other infrastructure elements.

### BACKGROUND

Infrastructure, the underlying framework of components that provide essential resources and/or services, is a crucial foundation of modern civilization. Unfortunately, infrastructure information (e.g., installation year, material, and/or dimensions) is not always up to date, due to poor historical record keeping, changes in ownership, and/or changes over time as maintenance is performed on various infrastructure elements. Identifying and fixing the gaps in infrastructure components is costly and time consuming, particularly if undertaken for a large number of infrastructure components.

The governments and/or utility companies that own and maintain different infrastructure components have limited resources for identifying such gaps in infrastructure information, and for manually collecting and/or verifying infrastructure information for identified gaps. In turn, this makes it difficult to accurately assess which infrastructure components are most in need of maintenance and/or most at risk of failure.

### SUMMARY

In light of these challenges, there is a need for improved methods of imputing infrastructure information (e.g., also referred to as “attribute information”) for infrastructure components, to reduce and/or eliminate the need for manual collection and verification of data. Additionally, the imputed infrastructure information can be used to predict rate of failure (ROF) and/or remaining useful life (RUL), for use in prioritizing resources with respect to infrastructure maintenance.

Accordingly, some embodiments described herein include methods for imputing attribute information for infrastructure elements, based at least in part on known attribute information for other infrastructure elements. Such methods can assist governments and/or utility companies by removing the need to manually collect and/or determine attribute information for infrastructure elements, many of which may be difficult or expensive to access (e.g., pipes that are buried underground). In turn, this helping the relevant actors efficiently allocate resources for infrastructure maintenance.

In some embodiments, a method includes: at an electronic device with an input mechanism and a display, receiving known attribute information for each component of a network system, the components of the network system including a first plurality of pipes, a second plurality of pipes different from the first plurality of pipes, and a plurality of supply-side structures. At least one component of the network system is connected to another component of the network system. The known attribute information for the first plurality of pipes includes, for each respective pipe in the first plurality of pipes: respective location information for the respective pipe; and a respective value for a first characteristic for the first respective pipe, wherein the first characteristic is a characteristic other than location. The attribute information for the second plurality of pipes includes, for each respective pipe in the second plurality of pipes, respective location information for the respective pipe. The attribute information for the second plurality of pipes does not include values for the first characteristic for pipes in the second plurality of pipes. The known attribute information for the plurality of supply-side structures includes, for each respective supply-side structure of the plurality of supply-side structures, respective location information for the respective supply-side structure. The method includes determining, for each respective pipe of the second plurality of pipes, unknown attribute information, including: determining, based at least in part on the known attribute information for the plurality of supply-side structures and location information for the respective pipe of the second plurality of pipes, a first adjacent pipe, wherein the first adjacent pipe is a pipe of the first plurality of pipes or the second plurality of pipes, and wherein the first adjacent pipe is connected to the respective pipe of the second plurality of pipes; and determining, based at least in part on a respective value for the first characteristic for the first adjacent pipe, a first value for the first characteristic for the respective pipe of the second plurality of pipes.

Thus, methods are provided for imputing attribute information for infrastructure elements, hereby increasing the effectiveness and efficiency of infrastructure maintenance efforts.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 is a flow diagram illustrating an exemplary method for imputing attribute information for network elements, in accordance with some embodiments.

FIG. 2 illustrates exemplary network components, for which some attribute information is imputed, in accordance with some embodiments.

FIG. 3 illustrates an exemplary network representation, in accordance with some embodiments.

FIGS. 4A-4B illustrate exemplary adjacent pipes, for which some attribute information is imputed, in accordance with some embodiments.

FIGS. 5A-5B illustrate exemplary user interfaces for viewing, editing, and/or verifying imputed attribute information, in accordance with some embodiments.

Like reference numerals refer to corresponding parts throughout the several views of the drawings.

### DETAILED DESCRIPTION

The embodiments below reference infrastructure components, which include, but are not limited to, pipes, purification plants, distribution reservoirs, valves, fire hydrants, drains, and pipe junctions.

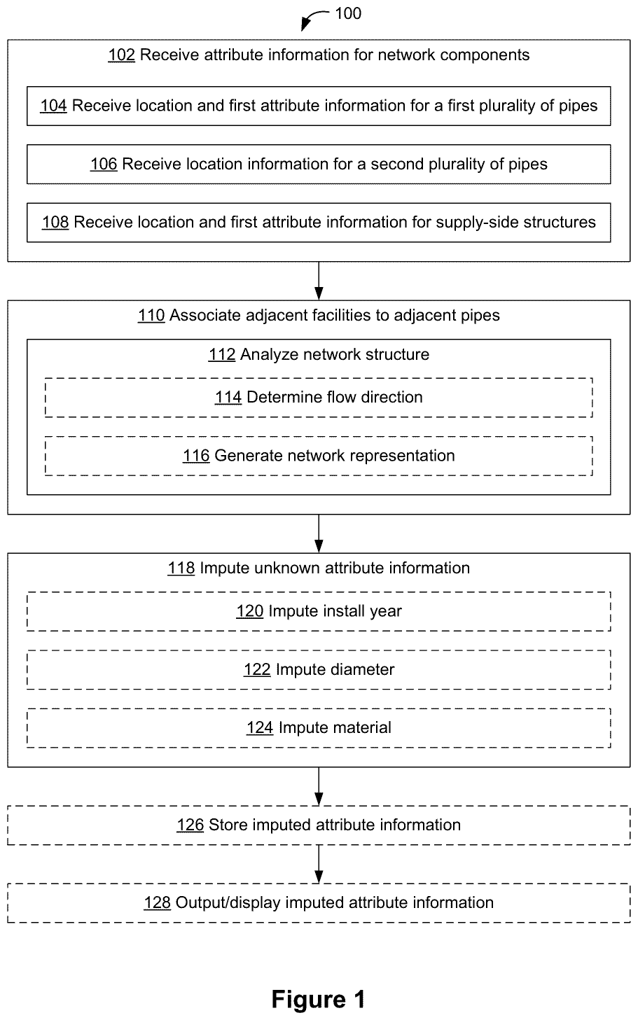

FIG. 1 is a flow diagram illustrating a method 100 of imputing attribute information for infrastructure elements. As shown in FIG. 1, some steps are represented with dotted lines to indicate that those steps are optional (e.g., are performed in some embodiments, but not performed and/or required in other embodiments).

A computer system receives (102) attribute information for network components. In some embodiments, the network components include infrastructure elements, such as pipes, purification plants, distribution reservoirs, valves, hydrants, drains, and/or pipe junctions. In some embodiments, one or more of the network components are connected (e.g., a purification plant is connected to a first pipe, which is connected to a valve, which is connected to a second pipe). In some embodiments, one or more network components are not connected to other network components (e.g., the computer system receives information for a purification plant, and a plurality of different pipes, but the plurality of pipes does not include the pipes immediately adjacent to (e.g., connected to) the purification plant).

Receiving the attribute information for the network components includes: receiving (104) location information (e.g., a location and/or geographic coordinate) and first attribute (e.g., location, year of installation, diameter, and/or material) information for pipes in a first plurality of pipes; receiving (106) location information for pipes in a second plurality of pipes (e.g., but not necessarily receiving any first attribute information for pipes in the second plurality of pipes, sometimes referred to as “missing attribute information” or “unknown attribute information”); and receiving (108) location information and first attribute information for supply-side structures (e.g., purification plants and/or distribution reservoirs).

In some embodiments, the computer receives attribute information for a plurality of attributes (e.g., year of installation, diameter, and material) for pipes in the first plurality of pipes (e.g., for each pipe in the first plurality of pipes). In some embodiments, the computer receives does not receive some attribute information for pipes in the second plurality of pipes (e.g., year of installation, diameter, and/or material is unknown for pipes in the second plurality of pipes). In some embodiments, the computer system receives a subset of attribute information (e.g., diameter, but not year of installation or material), for pipes in the second plurality of pipes.

In some embodiments, the first plurality of pipes is a subset of the second plurality of pipes. In some embodiments, the first plurality of pipes includes no more than 30% of the total number of pipes in the network (e.g., the total number of pipes included in both the first plurality of pipes and the second plurality of pipes). In some embodiments, the 30% threshold represent the minimum amount of known attribute information needed to accurately impute one or more unknown attributes via the method 100. In some embodiments, the first plurality of pipes includes more than 30% of the total number of pipes (e.g.,.

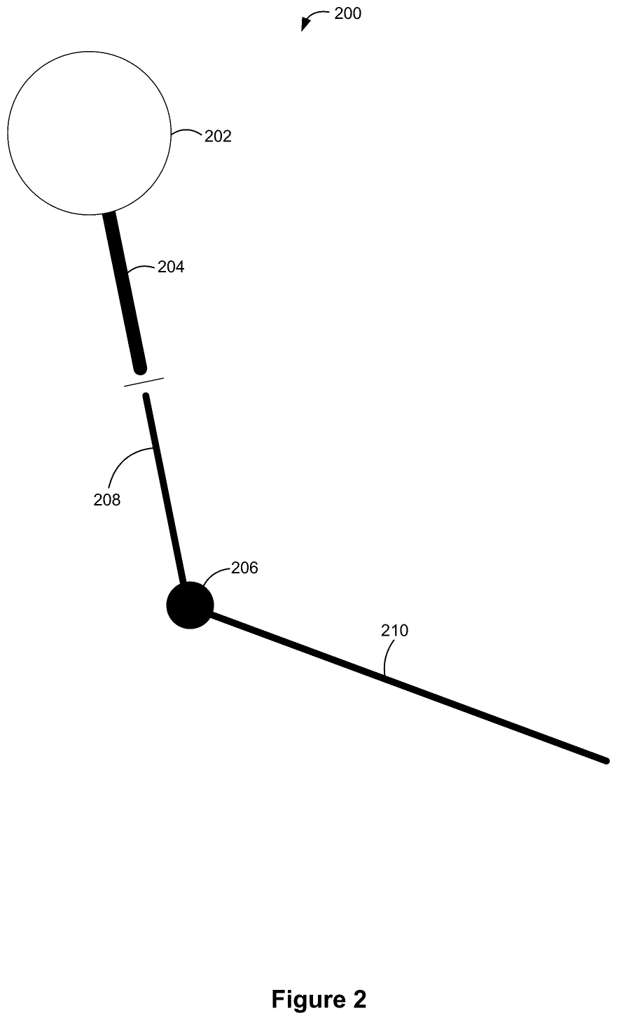

The computer system then associates (110) adjacent supply-side structures to adjacent pipes (e.g., the computer system determines which network components are connected to which supply-side structures, and/or the computer system determines which network components are connected to and/or adjacent to which other network components). Additional details regarding associating adjacent facilities and adjacent pipes are described in further detail below with reference to FIG. 2.

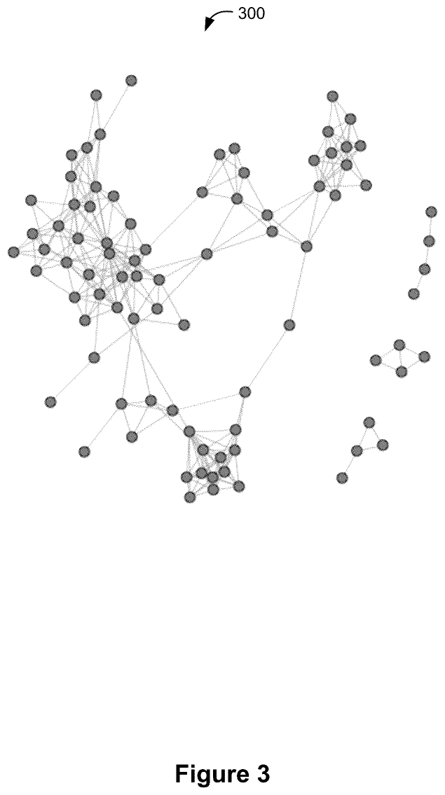

After associating adjacent facilities to adjacent pipes, the computer system analyzes (112) a network structure by determining adjacency for one or more other network components (e.g., one or more network components other than the supply-side structures and pipes associated in step 110). In some embodiments, the computer system determines (e.g., based at least in part on the received network components, location information, and known attribute information), a network representation of the network components. Additional details regarding an exemplary network representation are described in further detail below, with reference to FIG. 3.

In some embodiments, analyzing the network structure includes determining (114) a flow direction (e.g., a direction that water or gas flows through the network, or a portion of the network). In some embodiments, analyzing the network structure includes determining (e.g., for each pipe in the network) an upstream direction and a downstream direction (e.g., based on adjacent pipes and/or supply-side structures). For example, for a respective pipe, the computer system determines an upstream direction based on the location of the nearest supply-side structure (e.g., the nearest treatment plant or reservoir), wherein the upstream direction is determined to be in the direction of the supply-side structure (or an adjacent pipe, between the respective pipe and the supply-side structure, if the respective pipe is not directly adjacent to the supply-side structure), and the downstream direction is determined to a direction that is opposite the upstream direction.

In some embodiments analyzing the network structure includes generating (116) a network representation (e.g., a visual representation of the network, as described in further detail with reference to FIG. 3).

The computer system imputes (118) values for the unknown attribute information for the second plurality of pipes. In some embodiments, the computer system imputes the unknown attribute information based at least in part on the known attribute information for the first plurality of pipes. In some embodiments, the computer system imputes unknown attribute information for a respective pipe based at least in part on known attribute information for an adjacent pipe or supply-side structure. In some embodiments, the computer system imputes unknown attribute information for a respective pipe based at least in part on imputed attribute information for an adjacent pipe (e.g., that the computer system previously imputed attribute information for, based at least in part on known attribute information for an adjacent pipe or supply-side structure).

In some embodiments, the computer system imputes (120) unknown attribute information that includes an install year for a respective pipe. In some embodiments, the computer system imputes (122) unknown attribute information that includes a diameter for a respective pipe. In some embodiments, the computer system imputes (124) unknown attribute information that includes a material for a respective pipe.

In some embodiments, the computer system stores (126) the imputed attribute information (e.g., in memory of the computer system, which is optionally a server or database). In some embodiments, the computer system outputs or displays (128) the imputed attribute information (e.g., via a user interface displayed on a display of the computer system, enabling human verification, editing, selecting, and/or confirmation of some or all of the imputed attribute information.

Although some of various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages could be implemented in hardware, firmware, software or any combination thereof.

FIG. 2 illustrates an exemplary subset 200 of network components, for which the computer system determines adjacency (e.g., as in step 110 of the method 100 described above with reference to FIG. 1). The description of FIG. 2 below is made with reference to determining adjacency of a pipe with a supply-side structure, but analogous processes are applicable to determining adjacency of a pipe with another pipe.

The subset 200 of network components includes a distribution reservoir 202 (e.g., a supply-side structure), a pipe 204, a valve 206, a pipe 208, and a pipe 210. The pipe 204 has a larger diameter than the pipe 208 and the pipe 210 (e.g., as shown by the line representation the pipe 204 depicted as thicker than the lines representing the pipe 208 and the pipe 210).

In some embodiments, the computer system determines adjacency based on at least one known attribute (e.g., installation year, diameter, and/or material), optionally in combination with the known location information for each network component. In some embodiments, the computer system determines adjacency for the distribution reservoir 202 by determining which pipe has the smallest distance from the supply-side structure (e.g., by comparing known location information for the distribution reservoir 202, and the pipes in the network).

In some embodiments, the one or more known attributes (e.g., other than location information) are used to validate a respective pipe that is determined to be adjacent to the respective supply-side structure. For example, in the physical world, the pipe 204 is physically connected to the distribution reservoir 202 (e.g., so the method 100 described above with reference to FIG. 1 should result in the computer system determining, and verifying, that the pipe 204 is adjacent to the distribution reservoir 202). If the computer system initially determines that the pipe 204 is adjacent to the distribution reservoir 202 (e.g., based on known location information), the computer system compares the installation year (e.g., and/or the diameter) of the pipe 204 and the distribution reservoir 202. If the computer system determines that the installation year (e.g., and/or the diameter) of the pipe 204 and the distribution reservoir 202 match (e.g., or are within a threshold value, such as +/−1 year), the computer system verifies that the pipe 204 should be adjacent to the distribution reservoir 202.

If, however, the computer system initially determines that the pipe 208 should be adjacent to the distribution reservoir 202 (e.g., based on known location information), the computer system compares the installation year (e.g., and/or the diameter) of the pipe 208 and the distribution reservoir 202. If the pipe 208 has a different installation year (e.g., and/or diameter) compared to the distribution reservoir 202, the computer system does not verify that the pipe 208 should be adjacent to the distribution reservoir 202, and the computer system attempts to verify another pipe for adjacency (e.g., if the pipe 208 was initially selected because the pipe 208 was determined to be the closest pipe to the distribution reservoir 202, the computer system selects the next closest pipe to the distribution reservoir 202 and verifies if the installation year and/or diameter of the next closest pipe matches the distribution reservoir 202).

In some embodiments, the computer system determines adjacency based on a combination of known location and attribute information. For example, the location and each known attribute are each assigned a (e.g., probability) weight, and the computer system determines a probability that a respective pipe is adjacent to the distribution reservoir 202 based on the known location and attribute information (e.g., location has the highest weight, and for pipes which otherwise have the same installation year and diameter, the pipes that are closer to the distribution reservoir 202 are assigned a higher probability) for each pipe within a threshold distance from the distribution reservoir 202 (e.g., or optionally, for each pipe in the network).

In some embodiments, the computer system determines a plurality of adjacent pipes for a respective supply-side structure, optionally based on the type of supply-side structure. For example, the distribution reservoir 202 is assumed to have only one adjacent pipe (e.g., for outgoing flow), while the valve 206 is assumed to have two adjacent pipes (e.g., because the flow passes through the valve 206). The computer system determines adjacency in an analogous manner to the distribution reservoir 202 as described above, but instead selects two adjacent pipes (e.g., based on the pipes with the two highest probabilities for being adjacent to the valve 206). In some embodiments, for supply-side structures with multiple adjacent pipes, the computer system performs additional validation based on the multiple adjacent pipes. For example, the computer system validates, based on known location information, that the valve 206 is located between the pipe 208 and the pipe 210 (e.g., to ensure that it is physically possible for the valve 206 to be connected between the pipe 208 and the pipe 210).

In some embodiments, the computer system also determines an upstream and downstream direction. In some embodiments, one or more attributes are used to determine upstream and downstream directions. For example, the computer system assumes that pipes with larger diameters should be further upstream, compared to pipes with smaller diameters (e.g., because water mains, which are further upstream, have larger diameters than pipes in, or immediately adjacent to pipes in, individual buildings). In some embodiments, the computer system determines upstream and downstream directions based on a combination of attributes. For example, for pipes at a junction, the upstream and downstream directions are determined based on a combination of location and diameter. Location alone may be insufficient to determine whether the pipes actually form a junction (e.g., as opposed to there being multiple, but unconnected, groups of pipes in close proximity), and diameter is used to help inform which pipes are connected to which other pipes, and in what direction the flow direction runs through the connected pipes.

FIG. 3 illustrate an exemplary network representation 300 of the network components described with respect to the method 100 of FIG. 1. In FIG. 3, each node (e.g., represented as circles in FIG. 3) in the network representation 300 corresponds to a network component (e.g., a supply-side structure or a pipe), and the connections between the nodes (e.g., represented by the lines between the circles in FIG. 3) represent which network components are connected (e.g., adjacent to one another). In some embodiments, the relative positions of the nodes, and the length and/or orientation of the connections, are determined based at least in part on known location and/or attribute information (e.g., nodes that are connected by long connectors are physically distant from one another in the physical world). In some embodiments, the positions of the nodes, and/or the length/orientation of the connections, do not visually reflect known location and/or attribute information (e.g., the position of the nodes and/or length of the connectors are not to scale).

In some embodiments, the network representation 300 is constructed by determining adjacency sequentially. For example, starting from a respective supply-side structure, the computer system determines a first adjacent pipe by selecting the pipe with the shortest distance from the respective supply-side structure (e.g., the supply-side structure is the distribution reservoir 202, and the first adjacent pipe is the pipe 204, in FIG. 2). The computer system then determines a second adjacent pipe (e.g., the pipe 208 in FIG. 2) by selecting the pipe with the shortest distance from the first adjacent pipe. The computer system can repeat this process multiple times (e.g., until adjacency is determined for a subset of network components, or for all network components).

In some embodiments, the computer system calculates distances between network components (e.g., distances between different pipes, and/or between a supply-side structure and a pipe), and determines adjacency based at least in part on a shortest distance between two network components (e.g., the computer system determines that a respective pipe with the shortest distance between the respective pipe and a respective supply-side structure is adjacent to the respective supply-side structure).

In some embodiments, the computer system determines adjacency using a combination of known location information and known attribute information (e.g., as described above with reference to FIG. 2). In some embodiments, the computer system uses a first combination of known location information and known attribute information for determining adjacency of supply-side structures, and a second combination (e.g., distinct from the first combination) of known location information and known attribute information for determining adjacency of pipes. For example, the computer system uses known location information and installation year to determine which pipe is, or which pipes are, adjacent to supply-side structures; and the computer system uses known location information, installation year, and diameter to determine which pipes are adjacent to which other pipes.

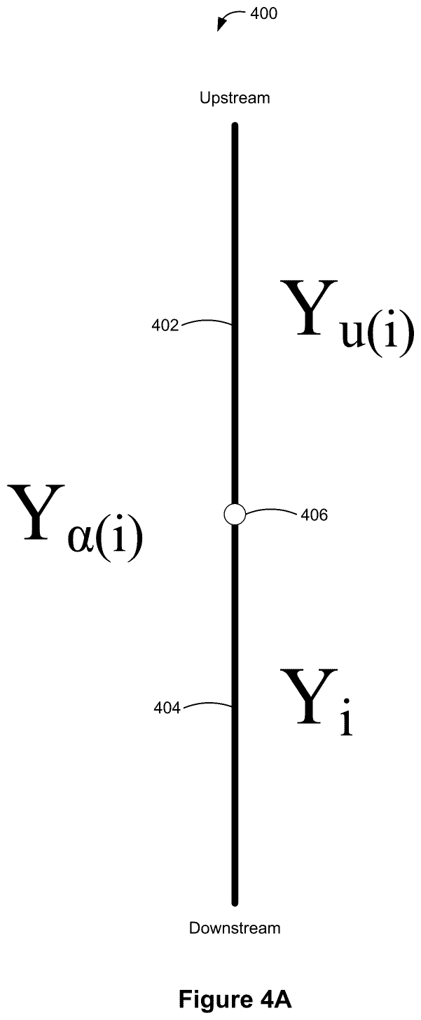

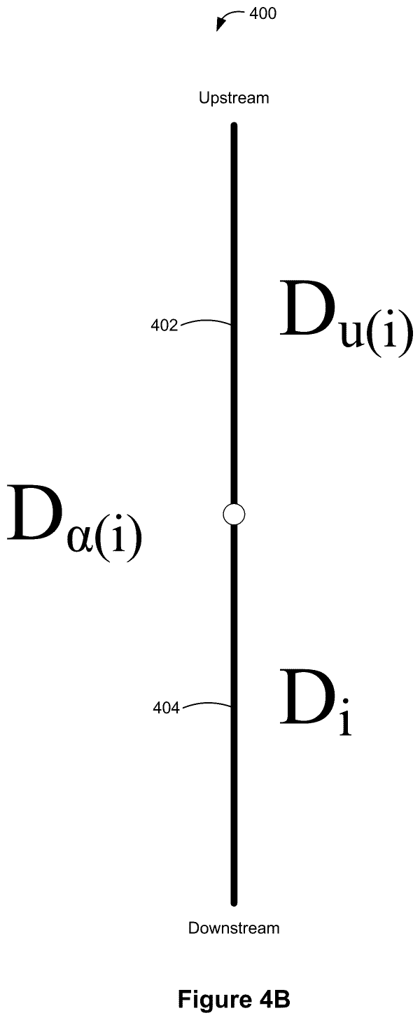

FIGS. 4A-4B illustrate exemplary adjacent pipes, for illustrating imputation of unknown attribute information for respective pipe. FIG. 4A illustrates two adjacent pipes, a pipe 402 and a pipe 404, which are both adjacent to (e.g., connected by) a supply-side structure 406. For ease of discussion, as used with respect to FIG. 4A, the term Y_{μ(i)} is sometimes used to describe the pipe 402 (e.g., the install year of the pipe 402), the term Yᵢ is sometimes used to describe the pipe 404 (e.g., the install year of the pipe 404), and the term Y_{α(i)} is sometimes used to describe the supply-side structure 406 (e.g., the install year of the supply-side structure 406). The descriptions of FIGS. 4A and 4B below provide some examples for how unknown attribute information can be imputed, in accordance with some embodiments. The FIGS. 4A-4B, and the accompanying descriptions, identify one method of imputing unknown attribute information, but one skilled in the art would recognize that other statistical models can be adapted to impute unknown attribute information in analogous ways.

In FIG. 4A, the installation year of the pipe 402 and the installation year of the supply-side structure 406 are known, and the installation year of the pipe 404 is not known. To impute the installation year of the pipe 404, the computer system first determines a minimum installation year (e.g., earliest installation year) and a maximum installation year (e.g., latest installation year) based on all components within the network. In some embodiments, the computer system determines a minimum installation year and a maximum installation year based on a subset of network components, wherein the subset of network components are network components that are directly, or indirectly, connected to the pipe 404. In some embodiments, the computer system determine a minimum installation year and a maximum installation year based on a subset of network components, wherein the subset of network components are network components that are in a particular downstream flow of network components (e.g., supply-side structures and pipes that are directly or indirectly connected to the pipe 404, and are also connected such that there is an uninterrupted and continuous flow in a single (e.g., downstream) direction from a most upstream network element of the subset, through the pipe 404 (if the pipe 404 is not the most upstream or most downstream network element of the subset), to the most downstream network element of the subset).

In some embodiments, the computer system determines a normal distribution (e.g., a Gaussian distribution) for the installation year of the network components (or a subset of network components, as described above). In some embodiments, the computer system imputes the installation year for the pipe 404 based on the normal distribution for the installation year (e.g., such that Yᵢ−Yᵤ₍ᵢ₎˜Normal (γ, σ_{γ}), wherein γ is the mean of the difference between upstream and downstream installation years for each network component (e.g., a difference between upstream and downstream installation year is determined for each network component, and γ is the mean of the determined differences), and σ_{γ}is the standard deviation for the difference between upstream and downstream installation years for each network component (e.g., a difference between upstream and downstream installation year is determined for each network component, and σ_{γ}is the standard deviation of the determined differences).

In some embodiments, the computer system also correlates the installation year for the pipe 404 with the installation year of adjacent supply-side structures (e.g., the supply side structure 406) (e.g., such that Y_{α(i)}−Yᵢ˜Normal (0, σ_{α})).

In some embodiments, the computer system imputes the installation year (e.g., separately) by material. For example, the computer system calculates the probability of the installation year of the pipe 404, as a function of the material, such that P(Yₘ|λₘ, μ, σ_{M})=Σₖ₌₁^{K}λ_{m,k}Normal(γ|μₖ, σ_{M}), wherein K is the unit simplex (e.g., defined as

$$K = ⌈ \frac{max ( I ) - min ( I )}{10} ⌉$$

(e.g., the number of decades present in the range of installation years)), λ is the mixing proportion (e.g., the proportion of pipes installed in a respective decade k), m is the material, and σ_{M} is the standard deviation for the distribution by material type (e.g., a respective pipe's material type is assumed at least in part based on the respective pipe's installation year, as pipes that are adjacent and installed at the same time are generally pipes of the same material type, and the standard deviation for the distribution by material type is a standard deviation of the installation years, banded by decade). In some embodiments, the computer system imputes the installation year for the pipe 404 by selecting the installation year with the highest probability.

FIG. 4B is analogous to FIG. 4A, but for the diameter of the network components (as opposed to the installation year of FIG. 4A). In some embodiments, the computer system determines a normal distribution (e.g., a Gaussian distribution) for the diameter of the network components (or a subset of network components, as described above). In some embodiments, the computer system imputes the diameter for the pipe 404 based on the normal distribution for the diameter (e.g., such that Dᵤ₍ᵢ₎−Dᵢ˜Normal (d, σ_{d}), wherein d is the mean of diameters for the network components, and Od is the standard deviation of the differences between upstream and downstream diameters for each network component (e.g., a difference between upstream and downstream diameter is determined for each network component, and od is the standard deviation of the determined differences).

In some embodiments, the computer system also correlates the diameter for the pipe 404 with the diameter of adjacent supply-side structures (e.g., the supply side structure 406) (e.g., such that D_{α(i)}−Dᵢ˜Normal (0, σ_{α})).

In some embodiments, the computer system imputes the diameter (e.g., separately) by material. For example, the computer system calculates the probability of the diameter of the pipe 404, as a function of the material, such that P(Dₘ|λₘ, μ, σ)=πₖ₌₁^{K}λ_{m,k}Normal(γ_{D}|μₖ, σₖ), wherein K is the unit simplex, λ is the mixing proportion, and m is the material). In some embodiments, the computer system imputes the installation year for the pipe 404 by selecting the installation year with the highest probability.

In some embodiments, some unknown attributes (e.g., material) are imputed using a different method. For example, the probability of a respective pipe being a respective material is defined as

$$P ( {m}_{j} \vert {Y}_{i} , {D}_{i} ) = \frac{P ( {Y}_{i} , {m}_{j} ) P ( {D}_{i} , {m}_{j} ) P ( {m}_{j} )}{{\sum }_{k = 1}^{M} P ( {Y}_{i} , {m}_{k} ) P ( {D}_{i} , {m}_{k} ) P ( {m}_{k} )}$$

(e.g., a Gaussian mixture model used, based on installation year and diameter). In some embodiments, if the installation year and/or diameter are not known, the computer system uses imputed values for the installation year and/or diameter (e.g., as described above with reference to FIGS. 4A-4B).

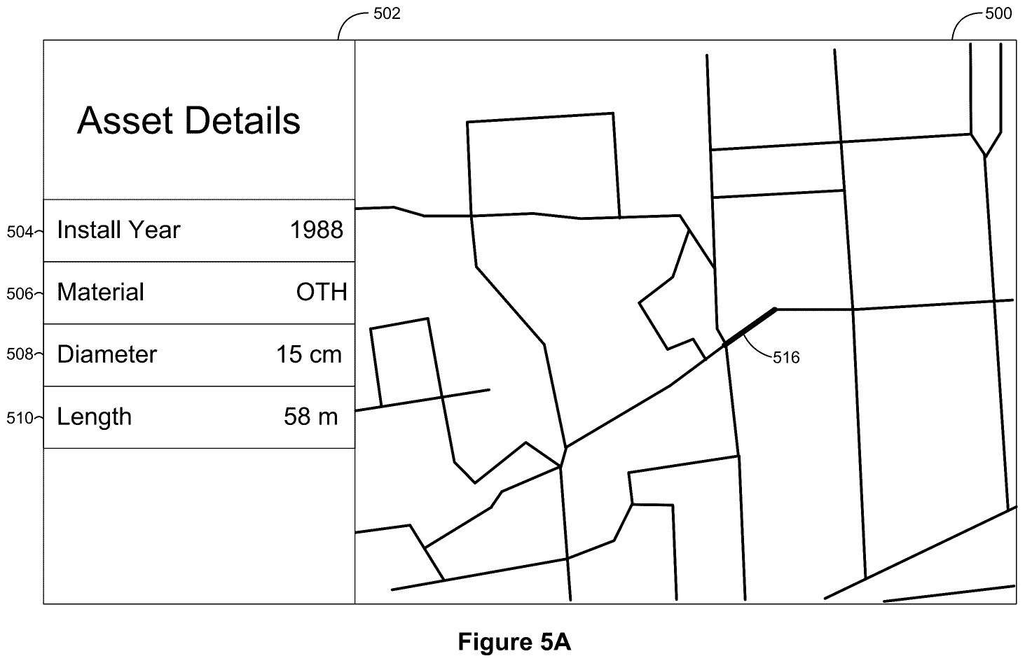

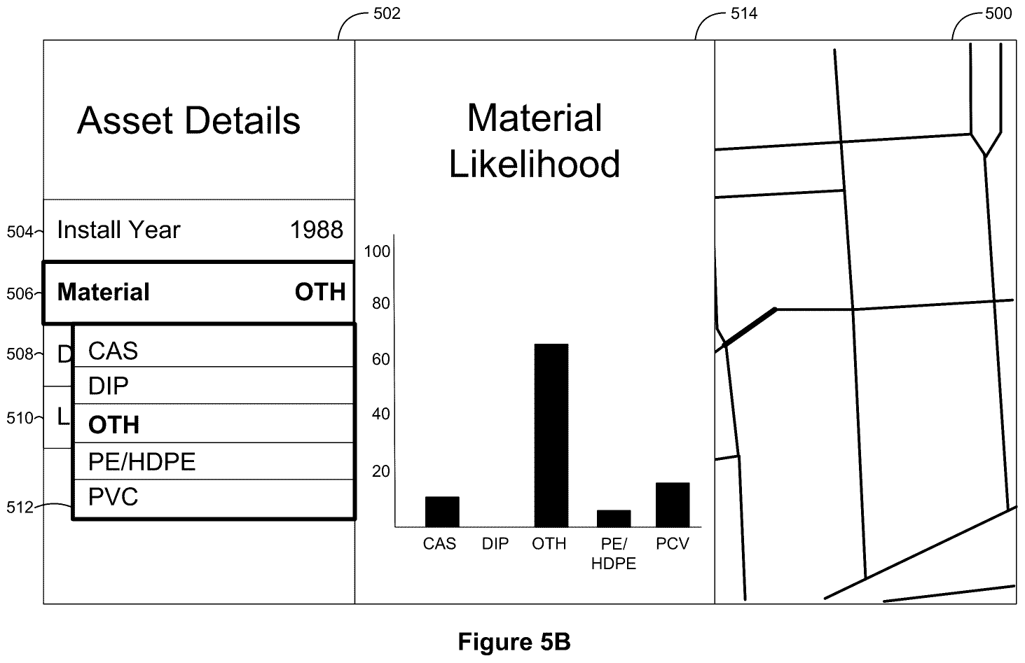

FIGS. 5A-5B illustrate exemplary user interfaces for viewing, reviewing, and editing imputed attribute information.

FIG. 5A shows a user interface 500, which includes a map of network components (e.g., pipes, as shown in FIG. 5A). In some embodiments, the map of network components in the user interface 500 includes network components for which attribute information is imputed (e.g., but optionally does not include network components for which all attribute information is known).

In some embodiments, a user selects a respective network component, such as the pipe 516, to display a user interface 502 that includes attribute information for the respective network component (i.e., the pipe 516). The user interface 502 includes an installation year section 504, a material section 506, a diameter section 508, and a length section 510. In some embodiments, the user interface 502 includes additional (or fewer) sections, depending on the context (e.g., in some embodiments, additional attributes beyond installation year, material, diameter, and length, are needed to determine which network components are most likely to require and/or benefit from maintenance efforts).

In some embodiments, each attribute (e.g., whether known or unknown) can be edited by the user (e.g., by selecting the relevant section). In some embodiments, only imputed attributes (e.g., attribute information imputed by the computer system via the method 100 described above with reference to FIG. 1) can be edited by the user.

In some embodiments, the selected network component is displayed with a visually distinct appearance, as compared to other network components in the user interface 500. For example, in FIG. 5A, the pipe 516 is displayed with a darker color (e.g., black instead of gray) and with a thicker width. In some embodiments, the visually distinct appearance is a different color. In some embodiments, the visually distinct appearance is a different size or thickness.

FIG. 5B shows that a user has selected the material section 506. In response, the computer system displays an editing user interface 512 for editing the imputed attribute information for the selected section. For example, the editing user interface 512 includes the other possible materials for the pipe 516. In some embodiments, the currently selected value is displayed with a visually distinct appearance (e.g., as shown by the bolded text for “OTH” in the editing user interface 512).

In FIG. 5B, the compute system also displays a probability user interface 514, which includes probability value for each possible material (e.g., calculated as described above, with reference to FIGS. 4A-4B). In some embodiments, the computer system automatically selects the material with the highest probability value (e.g., but displays the probability values for other materials, to assist the user in making corrections to the imputed material and/or verifying the selected material).

In some embodiments, the probability user interface 514 includes probability values for each imputed attribute (e.g., additional graphs for the probability values of installation year, diameter, and/or length, could be displayed in an analogous fashion to the probability user interface 514 of FIG. 5B). In some embodiments, the computer system displays the probability values for a respective attribute individually (e.g., as shown in FIG. 5B, for the material attribute), and the user can select different attributes to see the different probability values for those attributes. In some embodiments, the probability values for all attributes are concurrently displayed.

In some embodiments, the probability user interface 514 (e.g., or another suitable user interface, such as the user interface 502), includes a calculated “cost of failure” value, and/or a calculated “remaining useful life” value, which are optionally calculated based at least in part on the known and/or imputed attribute information for the respective network component.

In some embodiments, a user verifies the imputed attribute information. For example, each network component in the user interface 500 (e.g., for which attribute information has been imputed) is displayed with a first color (e.g., red). The user selects a respective network component to perform verification, and the computer system displays the selected respective network component with a second color (e.g., green) to provide visual feedback regarding which network component is being verified. After verifying and/or correcting the imputed attribute information, the computer system displays the respective network component with a third color (e.g., blue), to indicate that the respective network component has been verified.

It will also be understood that, although the terms first, second, etc. are, in some instances, used herein to describe various elements, these elements should not be limited by these terms. These terms are only used to distinguish one element from another. For example, a first current could be termed a second current, and, similarly, a second current could be termed a first current, without departing from the scope of the various described embodiments. The first computer system and the second computer system are both computer systems, but they are not the same computer system unless explicitly stated as such.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

What is claimed is:

1. A method, including:
at an electronic device with an input mechanism and a display:
receiving known attribute information for each component of a network system, the components of the network system including a first plurality of pipes, a second plurality of pipes different from the first plurality of pipes, and a plurality of supply-side structures, wherein:
at least one component of the network system is connected to another component of the network system;
the known attribute information for the first plurality of pipes includes, for each respective pipe in the first plurality of pipes:
respective location information for the respective pipe; and
a respective value for a first characteristic for the first respective pipe, wherein the first characteristic is a characteristic other than location; and
the known attribute information for the second plurality of pipes includes, for each respective pipe in the second plurality of pipes, respective location information for the respective pipe;
the known attribute information for the second plurality of pipes does not include values for the first characteristic for pipes in the second plurality of pipes;
the known attribute information for the plurality of supply-side structures includes, for each respective supply-side structure of the plurality of supply-side structures, respective location information for the respective supply-side structure;
determining, for each respective pipe of the second plurality of pipes, unknown attribute information, including:
determining, based at least in part on the known attribute information for the plurality of supply-side structures and location information for the respective pipe of the second plurality of pipes, a first adjacent pipe, wherein the first adjacent pipe is a pipe of the first plurality of pipes or the second plurality of pipes, and wherein the first adjacent pipe is connected to the respective pipe of the second plurality of pipes; and
determining, based at least in part on a respective value for the first characteristic for the first adjacent pipe, a first value for the first characteristic for the respective pipe of the second plurality of pipes.

2. The method of claim 1, including:
determining, based at least in part on the known attribute information for the plurality of supply-side structures and location information for the respective pipe of the second plurality of pipes, a flow direction;
determining, based on the flow direction, an upstream pipe, wherein the flow direction describes the direction of movement of material from the upstream pipe to the respective pipe of the second plurality of pipes; and
determining, based at least in part the respective value for the first characteristic for the upstream pipe, a first value for the first characteristic for the respective pipe of the second plurality of pipes.

3. The method of any of claims 1, wherein the first plurality of pipes is a subset of the second plurality of pipes.

4. The method of claim 3, wherein the first plurality of pipes includes no more than 30% of the total number of pipes included in both the first plurality of pipes and the second plurality of pipes.

5. The method of any of claims 1, wherein the first characteristic is a pipe material.

6. The method of any of claims 1, wherein the first characteristic is a year of installation.

7. The method of any of claims 1, wherein the first characteristic is a pipe diameter.

8. The method of any of claims 1, further including:
determining attribute information for each pipe of the second plurality of pipes;
after determining attribute information for each pipe of the second plurality of pipes, displaying a user interface that includes a plurality of representations of pipes that correspond to pipes of the second plurality of pipes;
detecting a first user input directed to a respective representation of a pipe that corresponds to a respective pipe of the second plurality of pipes;
in response to detecting the first user input, updating the user interface to display attribute information for the respective pipe of the second plurality of pipes, wherein:
displaying the attribute information includes displaying the determined value for the first characteristic for the respective pipe of the second plurality of pipes;
the determined value for the first characteristic for the respective pipe of the second plurality of pipes is configured to be editable by the user.

9. The method of claim 8, further including:
detecting a second user input editing the determined value for the first characteristic for the respective pipe of the second plurality of pipes;
in response to detecting the second user input:
updating the determined value for the first characteristic for the respective pipe of the second plurality of pipes in accordance with the second user input;
determining updated attribute information for each other pipe of the second plurality of pipes, based at least in part on the updated determined value for the first characteristic for the respective pipe of the second plurality of pipes.
